(19) United States
(12) Patent Application Publication
(10) Pub. No.: US 2009/0285420 A1
(43) Pub. Date: Nov. 19, 2009

(54) Device and Method for Producing a Surround Sound

(76) Inventor: Matthias Vierthaler, Denzlingen (DE)

Correspondence Address: O''Shea Getz P.C., 1500 MAIN ST. SUITE 912, SPRINGFIELD, MA, 01115, US

(21) Appl. No.: 12/467,963

(22) Filed: May 18, 2009

(30) Foreign Application Priority Data
May 16, 2008 (EP) 08 009 095.4

(51) Int. Cl. H04R 5/02

(52) U.S. Cl. 381/307

(57) ABSTRACT

A surround sound audio processing system includes a source that supplies a first signal for producing a first sound impression and a second signal for producing a second sound impression. A processing unit modifies the first signal and the second signal to produce a third sound impression of a virtual source, and provides first and second modified signals indicative thereof. The processing unit modifies the first signal and the second signal relative to each other such that the first and second modified signals have a phase shift of between 170° to 190°.

### PRIORITY INFORMATION

This patent application claims priority from European patent application 08 009095.4 filed May 16, 2008, which is hereby incorporated by reference.

### BACKGROUND OF THE INVENTION

The present invention relates to the field of audio systems, and in particular to a surround sound system.

Various systems for producing a surround sound are known. In particular, systems such as the Dolby Digital AC-3®, Dolby ProLogic II®, and DTS® systems, provide signals for front left, front center, front right, back left, and back right, which are connected to speakers that are arranged appropriately in the space surrounding a listener. A subwoofer for low-frequency signals may also be connected. There are also systems, such as, for example, the Dolby Pro Logic® surround sound processing technology that provide only one rear channel, which is arranged in the back center. All of these systems require one or more speakers be located in back of the listener. This is often not possible or not desired for reasons of space or for visual reasons.

For this reason, so-called virtual surround sound systems have been developed. These systems reproduce signals via a reduced number of speakers by mixing the signals together via special filters. For the listener, these systems produce the impression that the sound is coming from a “virtual” speaker, even though the latter is not physically present. The principle of this method is described, for example, by John C. Middlebrooks et al., in “Sound Localization by Human Listeners”, Annu. Rev. Psychol. 1991, 42:135-59. A common arrangement, especially for television sets, is, for example, to output the five channels for the signals left, center, right, surround left, surround right on the left and right speakers of the television set. Known examples of such virtual surround sound systems are, for example, the 3D Panorama® surround sound system of the assignee of the present invention, Micronas GmbH, which is installed in many television sets in Europe and Asia, the SRS TruSurround XT® system of the SRS company, or the Dolby Virtual Digital® system of the Dolby company.

FIG. 6 illustrates the principle of a prior art virtual surround sound system 600. If an actual acoustic source 602, to which a surround signal is applied, were to be placed at a position Lv, the right ear of a listener 604 would receive sound waves with a transfer function Hs, and the left ear 606 would receive sound waves with a transfer function Ha. The same listening impression will now be produced by processing signals SL′ of a first speaker L1 608 and signals SR′ of a second speaker L2 610 so as to modify them in such a way that, for the listener H, the impression that the signal S is coming from a virtual speaker LV is created. Sound waves of the two speakers L1, L2 reach the left ear and the right ear of the listener H with the transfer functions Vs1, Va1, Va2, and Vs2. The transfer functions Vs1, Va1, Va2, Vs2, Ha, and Hs are referred to as head-related transfer functions (HRTF). The design of these functions is described, for example, by Jyri Huopaniemi and Matti Karjalainen, in “Comparison of Digital Filter Design Methods for 3-D Sound”, IEEE Nordic Signal Processing Symposium (NORSIG96), Helsinki, Finland, Sep. 24-27, 1996.

This effect can be achieved, for example, via a cross cancellation network illustrated in FIG. 7 and the head-related transfer functions Vs, Va, Hs, and Ha, for which, by way of example, a surround sound signal S is applied. If the listener is situated midway between the two speakers L1 and L2, it can be assumed, for the sake of simplicity, that Vs=Vs1=Vs2 and Va=Va1=Va2. The following then holds true:

$$\begin{matrix}{SL}^{′} = S \cdot \frac{\overbrace{Hs \cdot Vs - Ha \cdot Va}^{Hi}}{{Vs}^{2} - {Va}^{2}} \\ and & ( EQ . 1 ) \\ {SR}^{′} = S \cdot \frac{\overbrace{Ha \cdot Vs - Hs \cdot Va}}{{Vs}^{2} - {Va}^{2}} . & ( EQ . 2 )\end{matrix}$$

Here, SL′ is the signal applied to the first speaker L1, which is modified according to EQ. 1. Correspondingly, SR′ is the modified second signal, which is applied to the second speaker L2. Vs1, Vs2 correspond to the portions of the signal that are passed from the two speakers L1, L2 to that ear of the listener on the same side of the listener's head and Va1, Va2 correspond to the portions of the signal that are passed from the speakers L1, L2 to the ear of the listener on the other side of the listener's head. Hs and Ha correspond to the transfer functions of the virtual acoustic source to the left ear and the right ear, respectively, of the listener. The transfer functions Hi and Hq combine the transfer functions according to EQ. 1 and 2.

Special attention should be paid to signals that come centrally from in back. Because, in this case, the right ear and the left ear of a listener receive exactly the same signals, a spatial localization of the signal is not possible and the sound seems to come centrally from in front. This effect is referred to in the literature as front-back confusion

Systems, such as, for example, the 3D Panorama® surround sound system from Micronas that process only one rear channel, address this problem by transforming this mono channel first into a so-called pseudo-stereo signal and then virtualizing it. Systems for producing a pseudo-stereo signal from a mono signal are known, for example, from the publication of the Audio Engineering Society, entitled “Stereophonic Techniques”, New York, 1986, pages 64-96.

Illustrated in FIG. 8 is a prior art system for producing a virtual surround sound from such a mono surround channel. Such a system, which is laid out on a monophonic surround input signal, can produce a good surround impression. However, this is achieved at the expense of an only imprecise localization of the signal source, because the signal comes from somewhere in back and seems to come generally from several directions. In this case, a surround signal is applied both to a processing unit designed as a delay element and an all-pass filter and to a module for multiplication by a transfer function Hq. The added output values of the two branches are supplied as a signal SR′ for the right speaker, for example. For the other speaker, its signal SL′ is supplied by addition from the output value of the circuit and the inverted output value of the module. These two signals SR′, SL′ are applied, together with additional signals R, C, L or R′, C′, L′, which are supplied for the right, center, and left channels, to a matrix 804. In the matrix 804, the signals of the channels SL′,SR′, namely, L′,R′,C′, are mixed on the two virtualized channels Lv and Rv, which are then output to the two speakers. This can take place, for example, in accordance with Lv=L′+0.5*C′+SL′, Rv=R′+0.5*C+SR′. Here, the reference signs of the output channels with respect to the input channels are marked with an apostrophe, it being possible, along the path between the corresponding inputs and outputs, to carry out additional signal processing, which, however, is not illustrated to simplify the illustration.

In contrast, in a surround sound system 900 as illustrated in FIG. 9, localization of the acoustic or signal source is possible. A listener has the impression that the signal is coming, for example, from back left or back right. Once again, a first signal SL and a second signal SR are supplied by a signal source 902. The first and second signals SL, SR, are applied to a plurality of transfer functions. In this case, there takes place, in a first transfer function 903a and in a fourth transfer function 903d, a processing with a first transfer function Hi, with the results being output to a first adder 904a and a second adder 904b. An output of the first adder 904a supplies the first modified signal SL′, which is applied to the matrix. An output of the second adder 908b supplies the second modified signal SR′, which is also applied to the output matrix. In addition, the first signal SL is applied to a third filter function 903c for processing with the transfer function Hq. After the multiplication, there takes place a phase shift of 180°, with the phase-shifted signal of the third filter function 903c being applied to a second input of the second adder 908b. Correspondingly, the second signal SR is applied to a second filter function 902b, in which it is processed with the transfer function Hq. The result, phase-shifted by 180°, is applied to a second input of the first adder 908a. The signals for front left (L), front right (R), and front center (C) are likewise applied to the matrix. From the signals SL′, SR′, L′, R′, and C′, the two signals Lv and Rv are produced by linear combination and output to the speakers L1 and L2. A simple example for the matrix may be, for example, Lv=L′+0.5*C′+SL′ as well as Rv=R′+0.5*C′+SL′.

Signals that come from back center, for which the signals SL and SR from the left and right, respectively, are the same, so that SL=SR holds true, are perceived, however, as if they were coming centrally from in front. For such signals, therefore, there no longer exists any stereo impression, this also being referred to as front-back confusion

Generally known from more complex systems is the addition of echoes. Different virtualization systems, including commercial virtualization systems, differ primarily in the selection of the head-related transfer functions.

European Patent EP 0 808 076 B1 describes a surround sound system having a source for spatial signals that contain a right signal and a left signal and additional signals that supplement the right and left signals to create a surround sound effect, with a modification circuit for stereo basis processing being provided, to which, of the spatial signals, only the pure right and left signals of the source are fed and for which the signals that supplement the surround sound effect contain a middle signal, which is combined additively with the output signals of the modification circuit, which form a modified right signal and a modified left signal.

The drawbacks of these systems are either only one monophonic surround signal can be processed, such that, after the virtualization, a precise spatial localization of the signal is not allowed, or stereophonic surround signals are processed, which allow a spatial localization of a sound from back left or back right. But even when a signal source supplies separate signals for back left and back right—for example, the Dolby AC-3® sound system, these channels often include a large portion of monophonic signals. These portions cannot be virtualized in back of the listener.

International Application WO 01/05187 A1 relates to a system that combines the advantages of the two methods mentioned above. A detection circuit identifies whether a large portion of the surround sound information is monophonic. If it is, the monophonic surround signal is transformed into a pseudo-stereo signal and only then virtualized. In this system, a signal processing is thus carried out dynamically, depending on the input signals.

There is a need for a surround sound system that improves the spatial impression and uses either monophonic surround signals or stereophonic surround signals.

### SUMMARY OF THE INVENTION

An objective is to develop a virtual surround sound system that conveys a good spatial impression for a “sweet spot” that is as large as possible, without, in doing so, necessarily having to place one or more speakers in back of the listener. The sweet spot is understood to refer to an area of the surrounding space in which a reproduction of sounds, in particular music or speech, achieves the optimally desired sound for a listener.

According to an aspect of the present invention, a device for producing a surround sound receives a first signal for producing a first sound impression and a second signal for producing a second sound impression, and processes the first and second signals to produce a third sound impression of a virtual source, and having terminals for outputting a first modified signal and a second modified signal. A phase-shifter modifies the first signal and the second signal relative to each other with a phase shift of 170° to 190°.

Surprisingly, it is possible by way of such an embodiment to achieve the impression of a signal coming from in back, when the signal portions of the two signals are equal in contribution, and, without such a phase shift, to achieve for the listener the impression of a signal coming from in front.

The phase-shifter may be laid out and/or controlled as a delay module for delayed output of the first modified signal and/or the second modified signal. The phase shifter may modify the first modified signal with a positive phase shift with respect to the first signal supplied by the signal source and modify the second modified signal with a negative phase shift in relation to the former with respect to the second signal supplied by the signal source. For example, the phase-shifter may modifying the first modified signal with a phase shift of +70° to +100°, and the second modified signal with a phase shift of −100° to −70°. Instead of the possibility of shifting only one of the modified signals by 180°, there also exists the possibility of shifting the two signals by ±90° to achieve an overall phase shift of 180°.

A first delay element and/or a first decorrelator delay(s) the first signal supplied by the signal source and apply(ies) it with a delay to a third adder for additive combination with the phase-shifted first signal. A second delay element and/or a second decorrelator delay(s), in a corresponding manner, the second signal supplied by the signal source and apply(ies) it with a delay to a fourth adder for additive combination with the phase-shifted second signal. In order to avoid a negative phase shift in practical implementation, one or both of the signals can be time-delayed, particularly in a first processing step, in order to then implement the shift of one of the signals, if desired, also in a negative direction. The two signals, however, can be shifted as well by a corresponding 90° and 270°, for example.

An adaptation module can form an adaptation value from the first and second signals supplied by the signal source and apply it to a third adder with a delay for additive combination with a phase-shifted first signal and to a fourth adder for additive combination with a phase-shifted second signal.

A rotation module can be laid out and/or controlled for cyclic rotation by 90°, in each case, of the phases of the first signal or of the first modified signal, of the second signal or of the second modified signal, and of the middle signal formed from the first and second signals or of one of the modified middle signals formed from the first and second modified signals.

The source can also supply additional signals for producing additional sound impressions for a left channel and a right channel, for example. In this case, the circuit layout for producing the third sound impression of the virtual source can advantageously have circuits for changing the phases of the first or the second signal and circuits for changing the phases of additional signals, with the circuits being laid out and/or controlled in conjunction with the phase-shifting arrangement to change at least the phase of a first of the additional signals with respect to the phase of the first modified signal by essentially +90° and the phase of the first of the additional signals with respect to the phase of the second modified signal by essentially −90°.

Achieved with such circuits or signal processing is a good spatial localization for signal components coming from back left/right and, simultaneously, also a good spatial impression for signal components coming centrally from in back. Preferred circuits can be implemented both for monophonic and for stereophonic surround signals, without a detection circuit being necessary for this. As a result, the complexity of the device is reduced and negative influences due to regulation and the time constants thereof are avoided.

Instead of an implementation with a plurality of individual components, an implementation may also take place by way of one or more processors for signal processing, which are then appropriately actuated or programmed so as to perform the signal processing.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 is a block diagram illustration of a surround sound system;

FIG. 2 is a block diagram illustration of a second surround sound system;

FIG. 3 is a block diagram illustration of a third surround sound system;

FIG. 4 illustrates another embodiment of a surround sound system;

FIG. 5 is a block diagram illustration of yet another surround sound system embodiment;

FIG. 6 is a pictorial illustration of a system that produces a surround sound for a listener;

FIG. 7 is a block diagram illustration of a cross-cancellation network and head-related transfer functions for it;

FIG. 8 is a block diagram illustration of a prior art surround sound system for a monophonic surround input signal; and

FIG. 9 is a block diagram illustration of a prior art surround sound system for a stereophonic surround input signal.

### DETAILED DESCRIPTION OF THE INVENTION

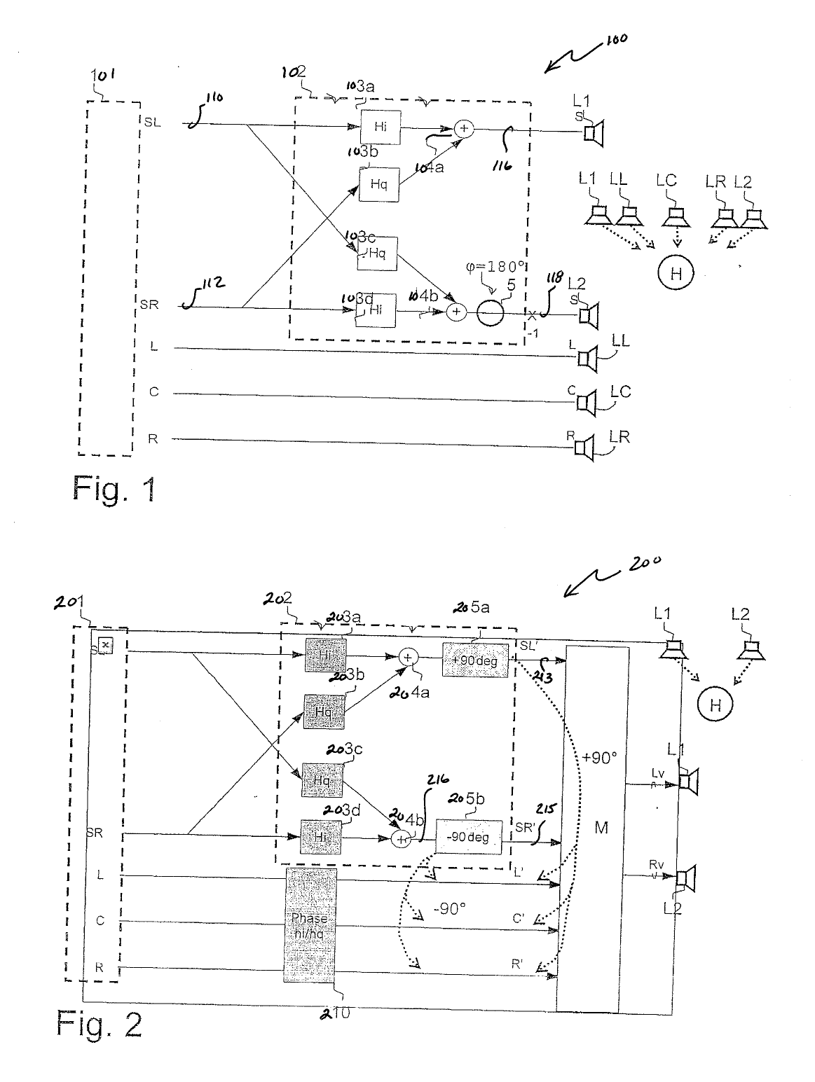

FIG. 1 illustrates a surround sound system 100, in which a signal source 101, such as, for example, a decoder or a DVD player, provides a first signal SL and a second signal SR, on lines 110, 112 respectively. In this case, the first signal SL is intended for output via a first speaker L1 and the second signal SR for output via a second speaker L2. Applied, however, to the two speakers L1, L2, instead of these signals SL, SR, are a modified first signal SL′ and a modified second signal SR′, so as to produce a surround sound that conveys the impression that, in addition, another signal of the middle signal kind is being output via yet another speaker as a virtual middle speaker.

The first signal SL on the line 110 is applied to a first multiplication term 103a and the second signal SR on the line 112 is applied to a second multiplication term 103b. The resultant products are summed by summer 104a and the resultant sum is output on line 116 to the first speaker L1. The first signal SL on the line 110 is also applied to a third multiplication term 103c and the second signal SR is applied to a fourth multiplication term 103d. The resultant products are summed by summer 104b and the resultant sum is output to a phase shifter 105, which applies a 180 degree phase and outputs a signal on line 118 to the second speaker L2. The transfer functions can be designed as complex and/or frequency-dependent factors. Significantly, the phase is not inverted immediately after the filters Hq, as would be the case conventionally for a cross-cancellation filter.

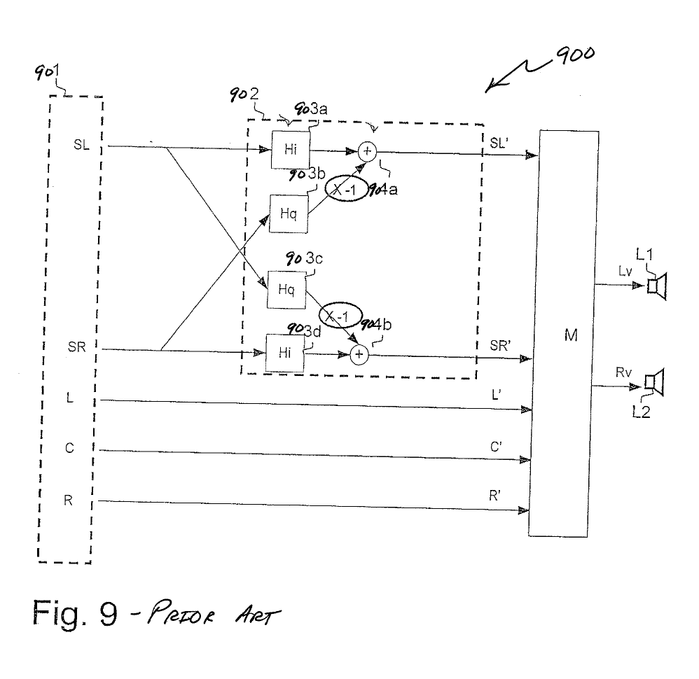

The effect of the signal processing of this embodiment is illustrated by the following table in comparison to the effect for a circuit layout of the prior art in accordance with FIG. 9.

| Signal | FIG. 9 | FIG. 1 | Comments |
|---|---|---|---|
| Only SL | SL′ = Hi * SL | SL′ = Hi * SL | Both the same |
| | SR′ = −Hq * SL | SR′ = −Hq * SL | |
| Only SR | SL′ = −Hq * SR | SL′ = Hq * SR | Both 180° |
| | SR′ = Hi * SR | SR′ = −Hi * SR | phase-rotated |
| SL = SR | SL′ = SL * (Hi − Hq) | SL′ = SL * (Hi + Hq) | FIG. 9: SL′ = SR′-> No |
| | SR′ = SL * (Hi − Hq) | SR′ = −SL * (Hi + Hq) | surround, FIG. 1: |
| | | | Opposite phased |

Three cases are compared in the table. According to the first case, only the first signal SL is applied. According to the prior art system illustrated in FIG. 9, the first modified signal is then output from the first speaker L1 as the product of the first transfer function Hi with the first signal SL. The second speaker L2 receives the second modified signal SR′ as the product of the first signal SL with the negative second transfer function Hq. In the case of the system illustrated in FIG. 1, the same modified signals SL′, SR′ are output to the two speakers L1 and L2, respectively.

Referring to FIG. 9, when only the second signal SR is applied to the system, the first modified signal SL′ is output via the first speaker L1 as the product obtained from the second signal SR and the negative second transfer function Hq and, from the second speaker L2, the second modified signal SR′ is output as the product obtained from the first transfer function Hi and the second signal SR. In contrast to this, the system in accordance with FIG. 1, the same signals are output in terms of contribution from the two speakers, but the algebraic sign is reversed. This means that the signals output from the speakers L1, L2 of the two compared circuit layouts are phase-rotated by 180°.

In the third compared case, the components of the two signals SL, SR are the same. In the case of the system in accordance with FIG. 9, correspondingly the first modified signal SL′ is output through the first speaker L1 as the product of the first signal SL with the difference between the first and second transfer functions Hi−Hq. Ultimately the same signal is output as a second modified signal SR′ from the second speaker L2. In the system in accordance with FIG. 1, in contrast, the product obtained from the first signal SL and the addition value of the two transfer functions Hi+Hq is output as the first modified signal SL′ through the first speaker L1 and, from the second speaker L2, the negative value of the same product is output. In this case, for the prior art system illustrated in FIG. 9, the same signal SL′=SR′ is output through the two speakers L1, L2, so that no spatial surround effect arises. In a preferred embodiment as illustrated in FIG. 1, the two modified signals SL′, SR′ are output with opposite phases, so that a surround impression is created.

The first and the second modified signals SR′, SL′ are applied, together with additional signals R, C, L and R′, C′, L′, which are supplied for the right, center, and left channels, to their own speaker L1, L2, LR, LC, LL in each case. Advantageously, all five speakers L1, L2, LR, LC, LL are arranged in front of a listener H and nonetheless effect a customary surround sound. In spite of the effect of sounds from the back, an arrangement of speakers in back of the listener H can be dispensed with.

This first embodiment has a drawback, because, there, for certain signal ratios, the modified signals SL′, SR′ are no longer symmetric, because they are always opposite in phase. This disadvantageous effect only plays a role, however, when, simultaneously, an identical signal component is applied to the remaining channels and, in particular, to the signals for left, center, and right.

FIG. 2 illustrates a second embodiment of a surround sound system, which eliminates this drawback of the first embodiment. The symmetry can be reestablished by, instead of having opposite phases, shifting the surround sound channels or their signals SL, SR by ±90°, it being possible to accomplish this by way of, for example, a Hilpert transformation. To this end, the two signals output from first and second adders 204a, 204b are applied, in each case, to a phase-shifting module 205a and 205b, respectively, and shifted in it by +90° or −90°. The outputs of the two phase-shifting modules 205a, 205b supply the first and the second modified signals SL′ and SR′, respectively. The other components correspond to those illustrated in FIG. 1.

In this variant, the first and the second modified signals SR′, SL′ are applied, together with additional signals R, C, L and R′, C′, L′, which are supplied for the right, center, and left channels, to a matrix as an output matrix. In the matrix, the signals of the channels SL′, SR′, namely L′,R′,C′, are mixed on the two virtualized channels Lv and Rv, which are then output to the two speakers L1, L2.

In order to reestablish the symmetry in this case, it should hold true that the phase response of the transfer functions Hi and Hq is nearly identical. The phase response of the transfer functions Hi and Hq is copied in the path for the additional signals L, R, and C. This can be implemented preferably by way of delay elements or delay functions and all-pass filters in one or more processing blocks 210.

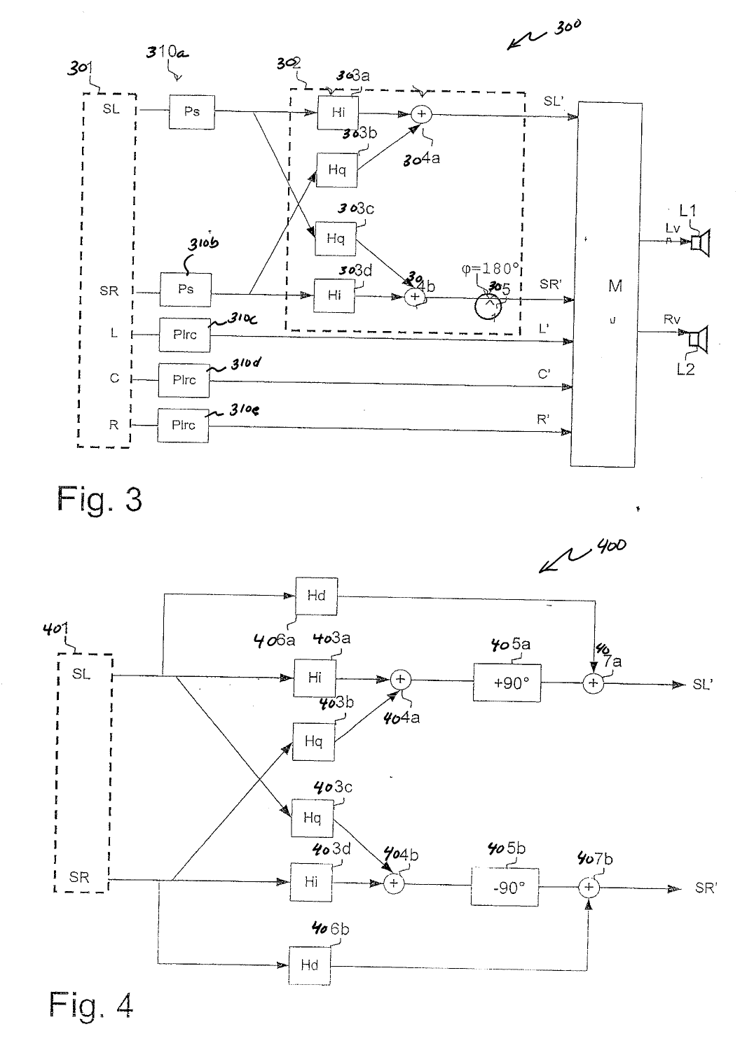

Instead of 0° for the first modified signal SL′ and 180° for the second modified signal SR′, as in the first embodiment illustrated in FIG. 1, the phase in this variant is rotated by ±90° for at least a part of the frequency range. This can be produced with all-pass filters. As a result, it is achieved that the phase of the left channel or its signal L′ is shifted by 90° with respect to the first modified signal SL′ and by −90° with respect to the second modified signal SR′. The same holds true for the two remaining additional signals C′ and R′, which are shifted by 90° with respect to the first modified signal SL′ and by −90° with respect to the second modified signal SR′. The phase of the first modified signal SL′ with respect to the phase of the second modified signal SR′ should be 180°. Accordingly, the contributed value of the added left signal L′ and first modified signal SL′ is equal to the contributed value of the added right signal L′ and second modified signal SR′. This phase adaptation can take place in approximation and takes place preferably in a frequency-dependent manner. This adaptation is particularly important for frequencies that are important for the surround effect, that is, in the range of approximately 200 Hz-2 kHz. Such a shift by +90° cannot, in reality, be directly implemented. However, this effect can be achieved by rotating or phase-shifting the corresponding signal components L,R,C by −90°, this being easier to implement in the embodiment illustrated in FIG. 3. In this case, a decorrelation of the mono-surround components is carried out. The system schematically illustrated in the above section corresponds once again to the system in accordance with FIGS. 1 and 2.

Referring to FIG. 3, the phase shifts are implemented by several processing blocks 310a-310e for the surround components SL, SR and for the additional signals L, R, and C, respectively. The filters, preferably all-pass filters and delay elements, are implemented in such a way that the phase shifts take place particularly as described in regard to FIG. 2. The phase of the left signal L with respect to the phase of the first modified signal SL′ should be 90°; the phase of the right signal R with respect to the second modified signal SR′ should be −90°; the phase of the first modified signal SL′ with respect to the phase of the second modified signal SR′ should be 180°.

FIG. 4 illustrates another embodiment, in which a decorrelation of the mono components is carried out using a delay. Not illustrated, for the sake of simplicity, are the additional signals for the right, center, and left channels. The basis is the embodiment in accordance with FIG. 2. In contrast to the latter, there are two additional modules as decorrelation element and/or delay element 406a, 406b as well as a third adder 407a and a fourth adder 407b in the circuit layout. The first signal SL is correspondingly applied to the first decorrelation element and/or delay element 406a and, after an appropriate signal processing, to the third adder 407a for addition. The third adder 407a is connected behind the first rotation or phase-shifting module 405a and outputs at its output the first modified signal SL′. The second signal SR is applied to the second decorrelation element and/or delay element 406b, the output signal of which is applied to the fourth adder 407b. The fourth adder 407b is connected between the second phase-shifting module 405b and the second speaker L2 to supply the second modified signal SR′.

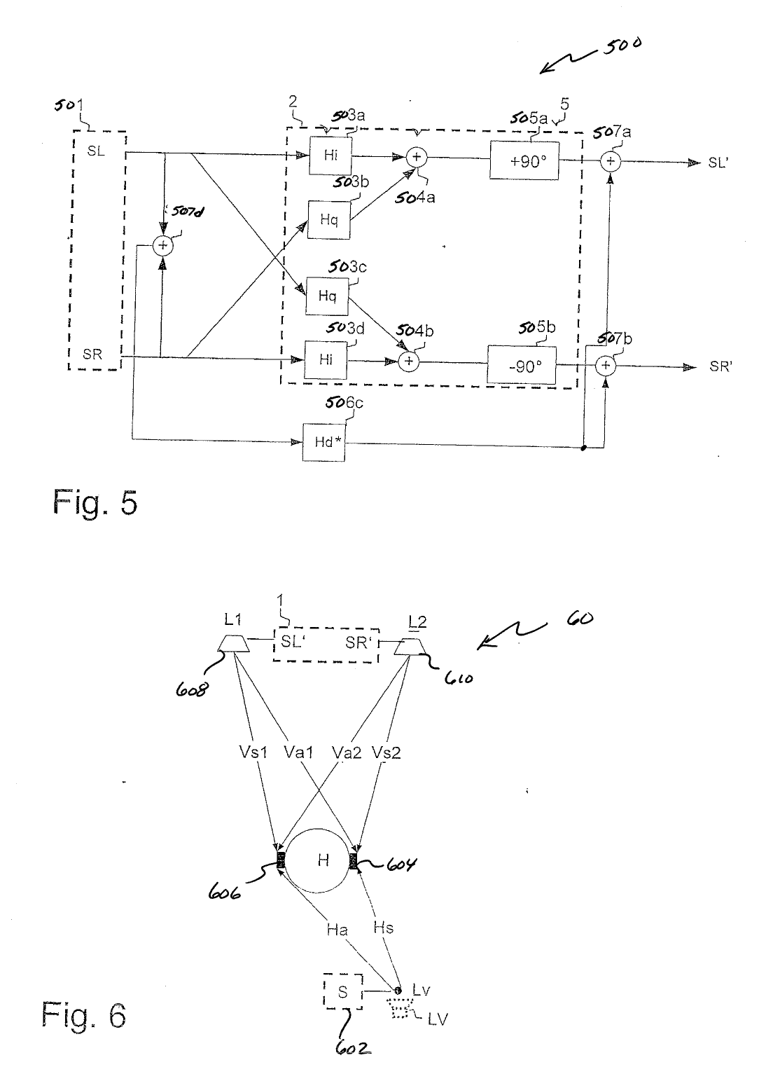

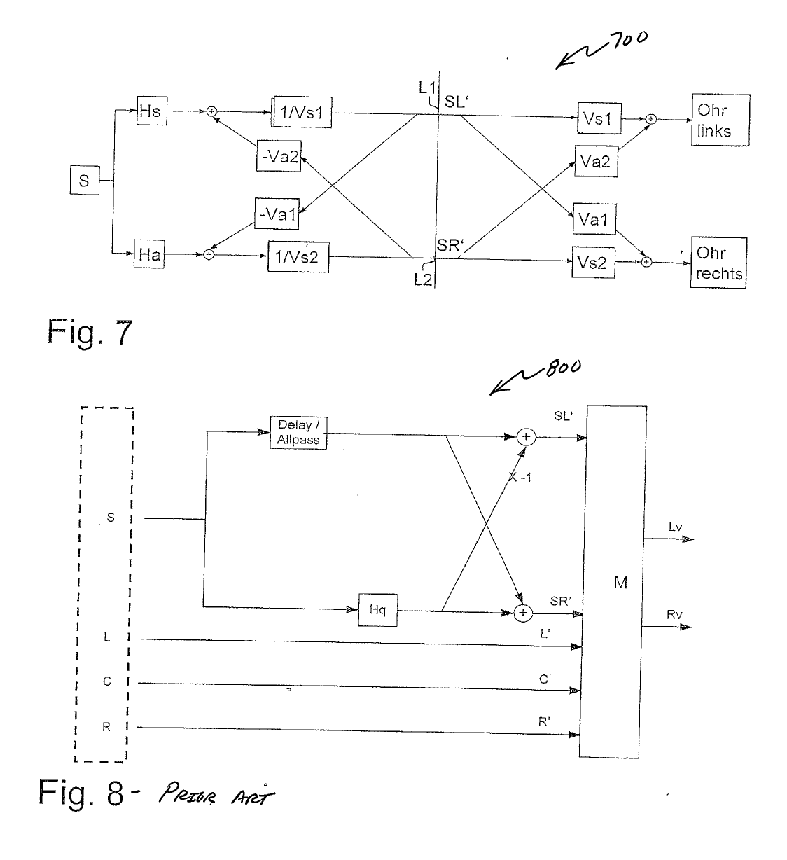

FIG. 5 illustrates yet another surround sound system. Initially supplied in an adaptation module by a fifth adder 507d is an addition signal, originating from, once again, the circuit layout in accordance with FIG. 2, with the fifth adder 507d adding, in each case, the instantaneous values of the first and second signals SL, SR. The output of the fifth adder 507d is applied to a decorrelation element and/or delay element 506c, the output value of which is applied to a third adder 507a as well as a fourth adder 507b. The third adder 507a is connected between the first phase-shifting module 505a and the first speaker L1 for supplying the first modified signal SL′. The fourth adder 507b is connected between the second phase-shifting module 505b and the second speaker L2 so as to output the second modified signal SR′.

Although the present invention has been illustrated and described with respect to several preferred embodiments thereof, various changes, omissions and additions to the form and detail thereof, may be made therein, without departing from the spirit and scope of the invention.

What is claimed is:

1. A surround sound audio processing system, comprising:
a source that supplies a first signal for producing a first sound impression and a second signal for producing a second sound impression;
a processing unit for modifying the first signal and the second signal to produce a third sound impression of a virtual source, and provides first and second modified signals indicative thereof; and
wherein the processing unit modifies the first signal and the second signal relative to each other such that the first and second modified signals have a phase shift of between 170° to 190°.

2. The system of claim 1, wherein the processing unit includes a phase shifter that phase shifts the second modified signal with a phase shift of 180° with respect to the first modified signal.

3. The system of claim 1, wherein the processing unit comprises a first phase shifter that applies a first phase shift to the first modified signal and a second phase shifter that applies a second phase shift to the second modified signal, such that the first and second modified signals have a phase difference of between about 170 to 190 degrees.

4. The system of claim 3, where the first phase shifter applies a phase shift of about 70 to 100 degrees while the second phase shifter applies a phase shift of about −100 to −70 degrees.

5. The system of claim 4, wherein
a first delay element and/or a first decorrelator delay(s) the first signal supplied by the signal source and apply(ies) it with a delay to a third adder for additive combination with the phase-shifted first signal and
a second delay element and/or a second decorrelator delay(s) the second signal supplied by the signal source and apply(ies) it with a delay to a fourth adder for additive combination with the phase-shifted second signal.

6. The system of claim 1, wherein
an adaptation module forms an adaptation value (Hd*) from the first and second signals supplied by the signal source and applies it to a third adder with a delay for additive combination with a phase-shifted first signal and to a fourth adder for additive combination with the phase-shifted second signal.

7. The system of claim 1, wherein a rotation module is laid out and/or controlled for the cyclic rotation by 90°, in each case, of the phases of the first signal or of the first modified signal, of the second signal or of the second modified signal, and of a middle signal formed from the first and second signals or of one of the modified middle signals formed from the first and second modified signals.

8. The system of claim 1, wherein
the source supplies additional signals (L, R, C) for producing additional sound impressions, and
means for producing the third sound impression of the virtual source comprises means for changing the phases of the first or the second signal, and means for changing the phases of additional signals (L, R, C), so as to change at least the phase of a first of the additional signals (L) with respect to the phase of the first modified signal (SL′) by +90° and the phase of the first of the additional signals (L) with respect to the phase of the second modified signal (SL′) by −90°.

9. A method for producing a surround sound, wherein
at least one first signal (SL) for producing a first sound impression and one second signal (SR) for producing a second sound impression are supplied and the first signal (SL) and the second signal (SR) are modified for producing a third sound impression of a virtual source (SC) and output as a first signal modified in this way (SL′) and as a second signal modified in this way (SR′),
wherein during the modification, the first signal (SL) and the second signal (SR) are phase-shifted relative to each other with a phase shift (φ) of 170° to 190°.

10. The method of claim 9, wherein the phase shift (φ) is carried out with 180° relative to each other.

11. The method of claim 9, wherein
the first signal (SL) supplied or modified by the signal source and the second signal (SR) supplied or modified by the signal source is delayed and
the first signal (SL) is modified with a positive phase shift (φ) with respect to the first signal (SL) supplied by the signal source and
the second signal (SR) is modified in relation to the former with a negative phase shift (φ) with respect to the second signal (SR) supplied by the signal source.

12. The method of claim 11, wherein the first signal (SL) is shifted with a phase shift (φ) of +70° to +100°, particularly of +90°, and the second signal (SR) is shifted with a phase shift (φ) of −100° to −70°, particularly of −90°.

13. The method of claim 9, wherein
the first signal (SL) supplied by the signal source is decorrelated and/or delayed and added with a delay to the phase-shifted first signal and
the second signal (SR) supplied by the signal source is decorrelated and/or delayed and added with a delay to the phase-shifted second signal.

14. The method of claim 9, wherein an adaptation value (Hd*) is formed from the first and second signals (SL, SR) supplied by the signal source and the adaptation value is added with a delay both to the phase-shifted first signal and to the phase-shifted second signal.

15. The method of claim 9, wherein phases of the first signal (SL) or of the first modified signal, of the second signal (SR) or of the second modified signal, and of a middle signal (R) formed from the first and second signal (SL, SR) or a modified middle signal formed from the first and second modified signal are rotated by 90° in each case.
